(19) United States
(12) Patent Application Publication
(10) Pub. No.: US 2018/0218388 A1
(43) Pub. Date: Aug. 2, 2018

(54) RETARGETING ADVERTISING PRODUCT RECOMMENDING USER DEVICE AND SERVICE PROVIDING DEVICE, ADVERTISING PRODUCT RECOMMENDING SYSTEM INCLUDING THE SAME, CONTROL METHOD THEREOF, AND NON-TRANSITORY COMPUTER READABLE STORAGE MEDIUM HAVING COMPUTER PROGRAM RECORDED THEREON

(71) Applicant: SK Planet Co., Ltd., Gyeonggi-do (KR)

(72) Inventor: Min Ho HAN, Seoul (KR)

(73) Assignee: SK Planet Co., Ltd., Gyeonggi-do (KR)

(21) Appl. No.: 15/320,632

(22) PCT Filed: Dec. 11, 2015
(86) PCT No.: PCT/KR2015/013615

§ 371 Date: Dec. 20, 2016

(30) Foreign Application Priority Data
Apr. 23, 2015 (KR) 10-2015-0057009

(51) Int. Cl. G06Q 30/02

(52) U.S. Cl. CPC G06Q 30/0242; G06Q 30/0267

(57) ABSTRACT

Provided are a retargeting advertising product recommending user device and service providing device, an advertising product recommending system including the same, a control method thereof, and a non-transitory computer readable storage medium having a computer program recorded thereon. According to the present invention, when the retargeting advertising material is exposed, it is possible to determine the number of advertising materials to be exposed and an exposing location based on the response score for every advertising material calculated based on a click through rate, the sales rate, and the sales of the previously viewed product, the recommendation analysis product, and the advertiser product and the predetermined priority information and provides the advertising material to the terminal according to the previously determined number of advertising materials and the exposing location when the terminal requests an advertising.

### TECHNICAL FIELD

The present invention relates to a retargeting advertising product recommending user device and a service providing device, an advertising product recommending system including the same, a control method thereof, and a non-transitory computer readable storage medium having a computer program recorded thereon, and more particularly, to a retargeting advertising product recommending user device and a service providing device which, when a retargeting advertising material is exposed, determine a number of advertising materials to be exposed and an exposing location based on a response score for every advertising material calculated based on a click through rate, a sales rate, and the number of sales for every advertising material such as a previously viewed product, an recommendation analysis product, and an advertiser product and predetermined priority information, and when the terminal requests an advertising, provide the advertising material according to the number of advertising materials and the exposing location which are previously determined to the terminal, an advertising product recommending system including the same, a control method thereof, and a non-transitory computer readable storage medium having a computer program recorded thereon.

### BACKGROUND ART

A retargeting advertising system is a system which, when a user views a product through a site A and then accesses another site B or C, exposes the product viewed through the site A in another site B or C as an advertising.

The above-described retargeting advertising system induces the user to a product purchasing site using an intuitive memory for a product of interest of the user. However, since a product of interest of the user is mainly recommended as the retargeting advertising product, the advertising which is led to actual purchase is not so much and thus the effect of the advertising is lowered.

### RELATED ART DOCUMENT

### Patent Document

Korean Unexamined Patent Application Publication No. 10-2000-0030058 (entitled Advertising system and method using Internet web page)

### DISCLOSURE

### Technical Problem

An object of the present invention is to provide a retargeting advertising product recommending user device and a service providing device which, when a retargeting advertising material is exposed, determine a number of advertising materials to be exposed and an exposing location based on a response score for every advertising material calculated based on a click through rate, a sales rate, and the number of sales for every advertising material such as a previously viewed product, an recommendation analysis product, and an advertiser product and predetermined priority information, and when the terminal requests an advertising, provide the advertising material according to the number of advertising materials and the exposing location which are previously determined to the terminal, an advertising product recommending system including the same, a control method thereof, and a non-transitory computer readable storage medium having a computer program recorded thereon.

### Technical Solution

According to an aspect of the present invention, a service providing device includes a storage unit which stores product information on a plurality of products and advertiser product information provided from an advertising terminal; a communication unit which receives one or more product information corresponding to a viewed product, information on a specific site, and identification information of a user device which are transmitted from the user device; and a control unit which analyzes the received one or more product information to check one or more recommendation analysis product information and one or more advertiser product information among a plurality of product information stored in the storage unit, calculate a response score for every product attribute for the one or more product information, the one or more recommendation analysis product information, and the one or more advertiser product information, and determine a number of exposed accounts to be exposed and an exposing location based on the calculated response score for every product attribute and predetermined priority information.

In an embodiment of the present invention, the product information may include at least one of a product unique code, a product name, a product image, and product description information.

In an embodiment of the present invention, the control unit may calculate a response score for every product attribute for the one or more product information by adding a click through rate to a value obtained by multiplying a sales rate and sales on the one or more product information, calculate a response score for every product attribute for the recommendation analysis product information by adding a click through rate to a value obtained by multiplying a sales rate and sales on the recommendation analysis product information, and calculate a response score for every product attribute for the advertiser product information by adding a click through rate to a value obtained by multiplying a sales rate and sales on the advertiser product information.

In an embodiment of the present invention, according to the predetermined priority information, the priority may be higher in the order of the response score for every product attribute, the sales rate, the number of sales, the click through rate, the number of clicks, and the number of impressions.

In an embodiment of the present invention, when the advertising request information transmitted from the user device is received by means of the communication unit, the control unit may control the communication unit to transmit information on at least one advertising material and an exposing location to the user device based on the determined number of exposed accounts and the exposing location.

According to another aspect of the present invention, a control method of a service providing device includes: receiving one or more product information corresponding to a viewed product, information on a specific site, and identification information of a user device which are transmitted from the user device, by means of a communication unit; checking one or more recommendation analysis product information and one or more advertiser product information among a plurality of product information stored in a storage unit by analyzing the received one or more product information, by means of a control unit; calculating respectively response scores for every product attribute for the one or more product information, the one or more recommendation analysis product information and the one or more advertiser product information, by means of the control unit; and determining the number of exposed accounts to be exposed and exposing locations based on the calculated response score for every product attribute and predetermined priority information, by means of the control unit.

In an embodiment of the present invention, the calculating of a response score for every product attribute may include: calculating a response score for every product attribute for the one or more product information by adding a click through rate to a value obtained by multiplying a sales rate and sales on the one or more product information, by means of the control unit; calculating a response score for every product attribute for the recommendation analysis product information by adding a click through rate to a value obtained by multiplying a sales rate and sales on the recommendation analysis product information; and calculating a response score for every product attribute for the advertiser product information by adding a click through rate to a value obtained by multiplying a sales rate and sales on the advertiser product information.

In an embodiment of the present invention, the control method may further include: receiving advertising request information transmitted from the user device, by means of the communication unit; and controlling the communication unit to transmit information on at least one advertising material and the exposing location based on the determined number of exposed accounts and exposing location in response to the received advertising request information to the user device, by means of the control unit.

According to yet another aspect of the present invention, a computer program executing the methods according to the aforementioned embodiments may be stored in a non-transitory computer readable storage medium having a computer program recorded thereon.

According to still another aspect of the present invention, an advertising product recommending system includes: a service providing device which checks one or more recommendation analysis product information and one or more advertiser product information among a plurality of product information previously stored by analyzing one or more product information corresponding to a viewed product transmitted from a user device, calculates respectively response scores for every product attribute for the one or more product information, the one or more recommendation analysis product information, and the one or more advertiser product information, determines a number of exposed accounts to be exposed and exposing locations based on the calculated response score for every product attribute and predetermined priority information, and when the advertising request information transmitted from the user device is received by means of the communication unit, transmits information on at least one advertising material and an exposing location to the user device based on the determined number of exposed accounts and the exposing location; and a user device which receives information on the at least one advertising material and the exposing location transmitted from the service providing device in response to the advertising request information and displays the at least one advertising material based on the information on the exposing location.

### Advantageous Effects

According to the present invention, when the retargeting advertising material is exposed, it is possible to determine the number of advertising materials to be exposed and an exposing location based on the response score for every advertising material calculated based on a click through rate, the sales rate, the sales, and the like of the previously viewed product, the recommendation analysis product, the advertiser product, and the like, and the predetermined priority information and provides the advertising material to the terminal according to the previously determined number of advertising materials and the exposing location when the terminal requests an advertisement, thereby maximizing an advertising effect through the number of advertising materials to which a click through rate (CTR) and a sales rate are reflected according to a product attribute and an exposing location and increasing satisfaction of the user.

### BRIEF DESCRIPTION OF THE DRAWINGS

FIG. 1 is a block diagram illustrating a configuration of an advertising product recommending system according to an embodiment of the present invention.

FIG. 2 is a block diagram illustrating a configuration of a user device according to an embodiment of the present invention.

FIG. 3 is a block diagram illustrating a configuration of a service providing device according to an embodiment of the present invention.

FIG. 4 is a view illustrating an advertising platform architecture linked with a DMP platform according to an embodiment of the present invention.

FIG. 5 is a flowchart illustrating a control method of a retargeting advertising product recommending system according to an embodiment of the present invention.

FIG. 6 is a view illustrating an exposing location according to a priority according to an embodiment of the present invention.

FIG. 7 is a view illustrating a screen of a user device according to an exemplary embodiment of the present invention.

### MODE FOR INVENTION

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not be included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

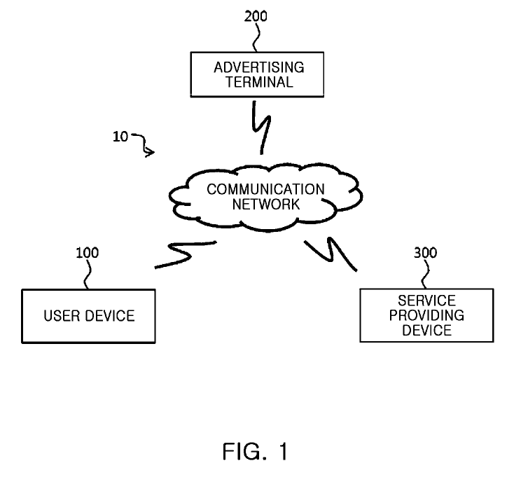

FIG. 1 is a block diagram illustrating a configuration of an advertising product recommending system 10 according to an embodiment of the present invention.

As illustrated in FIG. 1, the advertising product recommending system 10 is constituted by a user device 100, an advertising terminal 200, and a service providing device 300. All the constituent elements of the advertising product recommending system 10 illustrated in FIG. 1 are not essential constituent elements, and the advertising product recommending system 10 may be implemented by more constituent elements than the constituent elements illustrated in FIG. 1 or less constituent elements therethan.

The service providing device 300 collects one or more product information (or product information corresponding to a viewed product) checked by the user device 100 which accesses a specific site. Thereafter, the service providing device 300 checks respectively one or more recommendation analysis product information which is recommended based on one or more product information by the service providing device 300 and one or more advertiser product information among a plurality of advertiser product information provided from the advertising terminal 200. Next, the service providing device 300 calculates a response score for every product attribute for the viewed product, the recommendation analysis product, and the advertiser product. Next, the service providing device 300 determines the number of exposure accounts to be exposed and an exposing location based on the calculated response score for every product attribute and predetermined priority information which is set in advance. Next, when the service providing device 300 receives advertising requesting information which transmitted from the user device 100, the service providing device 300 transmits at least one advertising material to the user device 100, based on the number of exposure accounts and the exposing location which are previously determined in relation to the user device 100. Thereafter, the user device 100 receives the at least one advertising material transmitted from the service providing device 300 and displays the received at least one advertising material in accordance with the previously determined exposing location.

The user device 100 and/or the advertising terminal 200 may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (for example, including a smart watch, a smart glass, or a head mounted display (HMD)), a Wibro terminal, an internet protocol television (IPTV) terminal, a smart TV, a digital broadcasting terminal, a television, a 3D television, a home theater system, an audio video navigation (AVN) terminal, an audio/video (A/V) system, and a flexible terminal.

Further, the user device 100 and/or the advertising terminal 200 may be a terminal including a memory in which a browser, a program, and a protocol are stored to communicate with the server 300 via a communication network and a microprocessor which executes various programs to perform calculation and control.

That is, if it is possible to communicate with the server 300, any of terminals may be used as the user device 100 and/or the advertising terminal 200.

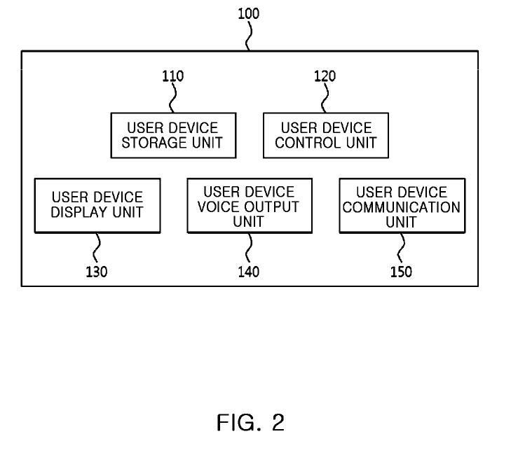

As illustrated in FIG. 2, the user device 100 is constituted by a user device storage unit 110, a user device control unit 120, a user device display unit 130, a user device voice output unit 140, and a user device communication unit 150. All the constituent elements of the user device 100 illustrated in FIG. 2 are not essential constituent elements, and the user device 100 may be implemented by more constituent elements than the constituent elements illustrated in FIG. 2 or less constituent elements therethan.

The user device storage unit 110 stores various user interfaces UI and graphic user interfaces GUI.

Further, the user device storage unit 110 stores data and programs required to operate the user device 100.

That is, the user device storage unit 110 may store a plurality of application programs (or applications) which are driven in the user device 100 and data and commands for operation of the user device 100. At least some of the application programs may be downloaded from an external server through wireless communication. In the meantime, the application program is stored in the user device storage unit 110 and provided in the user device 100 to be driven to perform an operation (or a function) of the user device 100 by the user device control unit 120.

Further, the user device storage unit 110 may include at least one storage medium of a flash memory type, a hard disk type, a multimedia card micro type, a card type memory (for example, an SD, XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the user device 100 may operate a web storage which performs a storing function of the user device storage unit 110 on the Internet or operate in association with the web storage.

Further, the user device storage unit 110 stores at least one advertising material (or at least one product information) which is transmitted from the service providing device 300 by the control of the user device control unit 120.

The user device control unit 120 performs an overall control function of the user device 100.

Further, the user device control unit 120 performs an overall control function of the user device 100 using a program and data stored in the user device storage unit 110. The user device control unit 120 may include a RAM, a ROM, a CPU, a GPU, and a bus and the RAM, the ROM, the CPU, the GPU, and the like are connected to each other through the bus. The CPU accesses the user device storage unit 110 to perform booting using an O/S stored in the user device storage unit 110 and performs various operations using various programs, contents, data, and the like stored in the user device storage unit 110.

Further, the user device control unit 120 interlocks with the service providing device 300 to perform a member joining procedure for the user of the user device 100.

Further, when the member joining procedure is performed, the user device control unit 120 normally completes the member joining procedure for the service providing device 300 only by completing an authentication function through a self-authentication unit (for example, including a mobile phone, a credit card, I-PIN, e-mail, and the like).

Further, when an application which is installed in advance in the user device 100 is executed, the user device control unit 120 displays an application executing result screen on the user device display unit 130.

Further, the user device control unit 120 controls the user device communication unit 150 to connect with the service providing device 300 (or perform a communication function).

Further, the user device control unit 120 accesses a specific site by means of the user device communication unit 150 to check one or more product information (or product) provided from the specific site. Here, the product information includes a product unique code, a product name, a product image, and product description information.

Further, the user device control unit 120 outputs the checked one or more product information through the user device display unit 130 and/or the user device voice output unit 140.

Further, the user device control unit 120 transmits the checked one or more product information (or product information corresponding to the viewed product), information on a specific site, identification information of the user device 100, and the like to the service providing device 300 through the user device communication unit 150. Here, the identification information of the user device 100 includes a mobile directory number (MDN), a mobile IP, a mobile MAC, a subscriber identify module (Sim) card unique information, and a serial number.

That is, the user device control unit 120 is provided with user device tracking log information including information on a product which is searched or purchased by the user device 100 through the specific site (for example, including a home shopping, a shopping mall, or the like) from the specific site and transmits the provided user device tracking log information, the information on the specific site, and the identification information of the user device 100 to the service providing device 300 through the user device communication unit 150. Here, the tracking log information includes product information which is searched by the user device 100, product view information, cart information (or product information put in a cart of the user device 100), and order information (product information for which payment is completed by the user device 100).

Further, the user device control unit 120 stores the user device tracking log information in the user device storage unit 110.

Further, when a predetermined advertising transmitting request menu (or an advertising transmitting request button) is selected in any one of status including a state when an application which is installed in advance in the user device 100 is executed, a state when the user device 100 accesses the service providing device 300, and a state when the user device 100 accesses another site, the user device control unit 120 generates advertising request information (or an advertising transmitting request signal). Here, the advertising request information may include information on a total number of accounts.

Further, the user device control unit 120 transmits the generated advertising request information to the service providing device 300 through the user device communication unit 150.

Further, the user device control unit 120 receives at least one advertising material (or at least one product information) which is transmitted from the service providing device 300 in response to the transmitted advertising request information and information on the exposing location of the advertising material through the user device communication unit 150.

Further, the user device control unit 120 outputs the received at least one advertising material based on the exposing location (or information on the exposing location/exposing location for every advertising material/exposing location information for every advertising material) determined in the service providing device 300 through the user device display unit 130 and the user device voice output unit 140.

The user device display unit 130 may display various contents such as various menu screens using a user interface and/or graphic user interface stored in the user device storage unit 110, by the control of the user device control unit 120. Here, the contents displayed on the user device display unit 130 may include a menu screen including various texts, image data (including various information data), and data such as icons, list menus, or a combo boxes. Further, the user device display unit 130 may be a touch screen. In this case, a touch sensor which detects a touch gesture of the user may be included. The touch sensor may be any one of various types such as a capacitive type, a decompressive type, or a piezoelectric type. In the case of the capacitive type, when a part of a user's body touches a surface of the touch screen by using a dielectric coated on the surface of the touch screen, a touch coordinate is calculated by sensing minute electricity excited to the user's body. In the case of the decompressive type, two electrode plates are embedded in the touchscreen, and when the user touches the screen, upper and lower electrode plates contact each other at the touched position and then current flows, and the touch coordinate is calculated by sensing the flow of the current. In addition to this, the user device supports a pen input function. In this case, a gesture of the user utilizing an input unit such as a pen, rather than the part of the body of the user, may be sensed. For example, when the input unit is a stylus pen in which a coil is included, the user device may include a magnetic field sensor for sensing a magnetic field changed by the coil in the stylus pen. In this case, an approaching gesture of the user such as hovering in addition to the touch gesture of the user may be sensed.

Further, the user device display unit 130 may be implemented by at least one of a liquid crystal display (LCD), a thin film transistor liquid crystal display (TFT LCD), an organic light emitting diode (OLED), a flexible display, a three dimensional display (3D display), an electronic ink (e-ink) display, and a light emitting diode (LED) and also include a driving circuit therefor and a back light unit together.

Further, the user device display unit 130 may be configured as a stereoscopic display unit which displays a stereoscopic image.

A 3D display type such as a stereoscopic type (a glasses type), an auto-stereoscopic type (a glassless type), and a projection type (a holographic type) may be applied to the stereoscopic display unit.

Further, the user device display unit 130 displays at least one advertising material which is transmitted from the service providing device 300 according to the predetermined exposing location by the control of the user device control unit 120.

The user device voice output unit 140 outputs voice information included in a signal processed by the user device control unit 120. Here, the user device voice output unit 140 may include a receiver, a speaker, a buzzer, and the like.

Further, the user device voice output unit 140 outputs a guidance voice generated by the user device control unit 120.

Further, the user device voice output unit 140 outputs voice information corresponding to the advertising material transmitted from the service providing device 300 by the user device control unit 120.

The user device communication unit 150 connects an arbitrary internal component with at least one arbitrary external terminal through a wired/wireless communication network to communicate each other. In this case, the arbitrary external terminal may include the advertising terminal 200 and the service providing device 300. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The user device communication unit 150 transmits and receives data in accordance with at least one wireless Internet technique within a range including also Internet techniques which are not described above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Furthermore, the wired communication technique may include power line communication (PLC), USB communication, Ethernet, serial communication, an optical/coaxial cable, or the like.

The user device communication unit 150 may mutually transmit information with any terminal through a universal serial bus (USB).

Further, the user device communication unit 150 transmits one or more product information (or product information corresponding to the viewed product) checked by the user device 100, the information on a specific site, and the identification information of the user device 100 to the service providing device 300 by the control of the user device control unit 120.

Further, the user device 100 may further include an interface unit (not illustrated) which functions as an interface with all external apparatuses which are connected to the user device 100. For example, the interface unit may be constituted by a wired/wireless headset port, an external charger port, a wired/wireless data port, a memory card port, a port connecting devices with identification modules, an audio input/output (I/O) port, a video input/output (I/O) port, an earphone port, and the like. Here, the identification module is a chip which stores various information for authenticating a permission of the user device 100 and may include a user identity module (UIM), a subscriber identity module (SIM), a universal subscriber identity module (USIM), and the like. Further, the device provided with the identification module may be prepared in a smart card form. Accordingly, the identification module may be connected with the user device 100 through the port. Such an interface unit receives data or power from an external device to transmit the received data or power to each component in the user device 100 or transmit the data in the user device 100 to the external device.

Further, the interface unit may be a passage through which the power from a cradle is supplied to the corresponding user device 100 when the user device 100 is connected to an external cradle or a passage through which various command signals input from the cradle by the user is transferred to the corresponding user device 100. Various command signals input from the cradle or the corresponding power may also operate by a signal for recognizing that the user device 100 is accurately installed on the cradle.

Further, the user device 100 may further include an input unit (not illustrated) for receiving a signal according to a button operation of the user or any function selection or receiving a command or a control signal created by an operation such as an operation of touching/scrolling the displayed screen.

The input unit as a means for receiving at least one of a user's command, selection, data, and information may include a plurality of input keys and function keys for receiving figure or text information and setting various functions.

Further, the input unit may use various devices such as a key pad, a dome switch, a touch pad (a pressure resistive type/a contact capacitive type), a touch screen, a jog wheel, a jog switch, a jog shuttle, a mouse, a stylus pen, and a touch pen. Particularly, when the user device display unit 130 is formed in a touch screen form, some or all of the input functions may be performed by the user device display unit 130.

Further, each component unit (or each module) of the user device 100 may be software stored on a memory (or the user device storage unit 110) of the user device 100. The memory may be an internal memory of the user device 100 and may an external memory or other types of storage devices. Further, the memory may be a non-volatile memory. The software stored on the memory may include a command set to allow the user device 100 to perform a specific operation while executing.

Further, the advertising terminal 200 interworks with the service providing device 300 to perform a member joining procedure for the user of the advertising terminal 200.

Further, when the member joining procedure is performed, the member joining procedure for the service providing device 300 may be normally completed only by completing the authentication function through a self-authentication unit (for example, including a mobile phone, a credit card, I-PIN, e-mail, and the like).

Further, the advertising terminal 200 generates (or creates) one or more advertisings (or advertising contents) by an advertising copywriter and stores one or more generated advertisings.

Further, the advertising terminal 200 provides (or transmits) advertiser product information and the identification information of the advertising terminal 200 which are provided by the advertiser who is a user of the advertising terminal 200 to the service providing device 300. Here, the advertiser product information includes a product unique code, a product name, a product image, and product description information.

As described above, the advertising terminal 200 provides one or more advertiser product information provided by an advertiser of the advertising terminal 200 to the service providing device 300 to provide the advertiser product information to another user device 100.

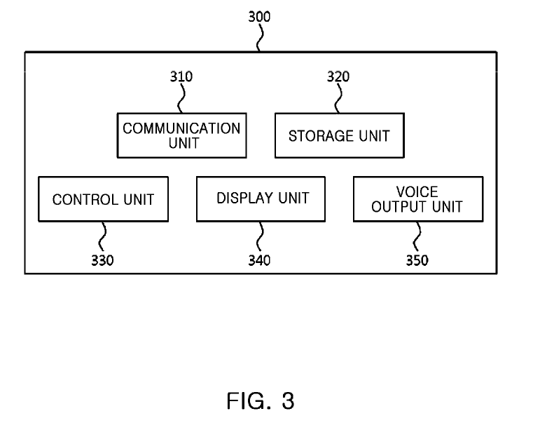

As illustrated in FIG. 3, the service providing device 300 is constituted by a communication unit 310, a storage unit 320, a control unit 330, a display unit 340, and a voice output unit 350. However, all the constituent elements of the service providing device 300 illustrated in FIG. 3 are not essential constituent elements, and the service providing device 300 may be implemented by more constituent elements than the constituent elements illustrated in FIG. 3 or less constituent elements therethan.

The communication unit 310 communicates with any internal constituent element or at least one arbitrary external terminal via a wired/wireless communication network. In this case, the arbitrary external terminal may include the user device 100 and the advertising terminal 200. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The terminal communication unit 150 transmits and receives data in accordance with at least one wireless Internet technique within a range including Internet techniques which are not listed above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Further, the wired communication technique may include power line communication (PLC), USB communication, Ethernet, serial communication, optical/coaxial cable, or the like.

Further, the communication unit 310 may mutually transmit information with any terminal through a universal serial bus (USB).

Further, the communication unit 310 receives one or more product information (or product information corresponding to the viewed product) checked by the user device 100, the information on a specific site, the identification information of the user device 100, and the like, which are transmitted from the user device 100, by the control of the control unit 330. Here, the product information includes a product unique code, a product name, a product image, and product description information. Further, the identification information of the user device 100 includes a mobile directory number (MDN), a mobile IP, a mobile MAC, a subscriber identify module (Sim) card unique information, and a serial number.

Further, the communication unit 310 receives the advertiser product information and identification information of the advertising terminal 200 which are transmitted from the advertising terminal 200 by the control of the control unit 330. Here, the advertiser product information includes a product unique code, a product name, a product image, and product description information.

The storage unit 320 stores various user interfaces UI and graphic user interfaces GUI.

Further, the storage unit 320 stores data and programs required to operate the service providing device 300.

That is, the storage unit 320 may store a plurality of application programs which are driven in the service providing device 300 and data and commands for operation of the service providing device 300. At least some of the application programs may be downloaded from an external server through wireless communication. In the meantime, the application program is stored in the storage unit 320 and installed on the service providing device 300 to be driven to perform an operation (or a function) of the service providing device 300 by the control unit 330.

Further, the storage unit 320 may include at least one storage medium of a flash memory type, a hard disk type, a multimedia card micro type, a card type memory (for example, an SD, XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the service providing device 300 may operate a web storage which performs a storing function of the storage unit 320 on the Internet or operate in association with the web storage.

Further, the storage unit 320 stores one or more product information (or product information corresponding to the viewed product) checked by the user device 100, the information on a specific site, the identification information of the user device 100, the advertiser product information, the identification information of the advertising terminal 200, and the like, which are received by the communication unit 310, by the control of the control unit 330.

The control unit 330 performs an overall control function of the service providing device 300.

Further, the control unit 330 performs an overall control function of the service providing device 300 using a program and data stored in the storage unit 320. The control unit 330 may include a RAM, a ROM, a CPU, a GPU, and a bus, and the RAM, the ROM, the CPU, the GPU, and the like may be connected to each other through the bus. The CPU accesses the storage unit 320 to perform booting using an O/S stored in the storage unit 320 and may perform various operations using various programs, contents, and data stored in the storage unit 320.

Further, the control unit 330 performs a member joining procedure for a user of the user device 100 and a user of the advertising terminal 200 by interworking with the user device 100 and the advertising terminal 200.

Further, the control unit 330 controls the communication unit 310 to receive one or more product information (or product information corresponding to the viewed product) checked by the user device 100, the information on a specific site, and the identification information of the user device 100 which are transmitted from the user device 100. Here, the product information includes a product unique code, a product name, a product image, and product description information.

That is, the control unit 330 controls the communication unit 310 to receive user device tracking log information transmitted from the user device 100.

Further, the control unit 330 controls the communication unit 310 to receive advertiser product information and identification information of the advertising terminal 200 which are transmitted from the advertising terminal 200. Here, the advertiser product information includes a product unique code, a product name, a product image, and product description information.

Further, the control unit 330 analyzes one or more product information (or product information corresponding to the viewed product) checked by the user device 100 to check one or more recommendation analysis product information on products of interest of the user of the user device 100 among a plurality of product information which is stored in advance in the storage unit 320.

That is, the control unit 330 checks one or more recommendation analysis product information related to the tracking log information corresponding to one or more product information checked by the user device 100, among a plurality of product information which is stored in advance in the storage unit 320.

Further, the control unit 330 analyzes one or more product information (or product information corresponding to the viewed product) checked by the user device 100 to check one or more advertiser product information among the plurality of advertiser product information which is stored in advance in the storage unit 320.

That is, the control unit 330 checks one or more advertiser product information corresponding to the tracking log information among the plurality of advertiser product information which is stored in advance in the storage unit 320.

Further, the control unit 330 calculates a response score for every product attribute for every advertising material such as one or more product information checked by the user device 100, the checked one or more recommendation analysis product information, and the checked one or more advertiser product information.

That is, the control unit 330 calculates a response score (or a response score for every product attribute) according to the product attribute based on a click through rate (CTR), a sales rate, sales, and the like for one or more product information checked by the user device 100 as represented in Equation 1.

Response score=Sales rate×Sales+Click through rate [Equation 1]

Here, the click through rate is represented by clicks/impressions×100 and the sales rate is represented by sales/clicks×100.

Further, the control unit 330 calculates the response score by the product attribute by Equation 1, based on the click through rate (CTR), the sales rate, and the sales for one or more recommendation analysis product information checked by the service providing device 300.

Further, the control unit 330 calculates the response score by the product attribute by the above-described Equation 1, based on the click through rate, the sales rate, the sales, and the like for the one or more advertiser product information provided from the advertising terminal 200.

Here, the response score for every product attribute is a score which becomes a reference to calculate an exposing ranking and a number of used accounts. In this case, in a calculating formula of the response score for every product attribute, since the sales rate and the number of sales are the most important scores, the control unit 330 uses the number of sales as a weight of the sales rate and also reflects (or applies) a click through rate corresponding to the feedback of the user.

Further, when the response scores for every product attribute (or response score) are equal to each other, the control unit 330 determines with respect to a response score having a higher priority based on the predetermined priority information.

Further, the control unit 330 determines (or sets) the number of advertising materials to be exposed (or the number of exposing accounts) and the exposing location based on the calculated response score for every product attribute and the predetermined priority information. Here, according to the predetermined priority information, the priority may be high in the order of the response score for every product attribute, the sales rate, the number of sales, the click through rate, the number of clicks, and the number of impressions.

That is, the control unit 330 determines a rate of the number of accounts to be exposed among the total number of accounts with a rate of a response score of a specific advertising material (for example, including the viewed product, the recommendation analysis product, and the advertiser product) among the total of the response scores for every product attribute which is previously calculated based on the following Equation 2. In this case, the values below decimal points are truncated.

Number of exposing accounts=Floor{(Response score for every product attribute/ΣResponse score for every product attribute of advertising receiver)×Total number of accounts} [Equation 2]

Here, a Floor operator is an operator which truncates values below the decimal point.

Further, when the number of exposing accounts is calculated, the control unit 330 calculates the number of exposing accounts in the order of higher priority, based on predetermined priority information.

Further, the control unit 330 subtracts the number of exposing accounts having a high priority attribute which is previously calculated from the total number of accounts, so that a problem in that the product is empty in the account is not caused.

Further, the control unit 330 determines the exposing location in the order of the product viewed in the user device 100, the recommendation analysis product, and the advertiser product, based on the predetermined priority information.

As described above, the control unit 330 determines a ratio for the specific advertising material (for example, including the viewed product, the recommendation analysis product, and the advertiser product) and the exposing location, for each of exposing accounts.

Further, the control unit 330 stores the determined exposing accounts and exposing location in the storage unit 320.

Further, the control unit 330 may perform a process of calculating a response score for every product attribute and a process of calculating the exposing accounts and the exposing location in the unit of predetermined time (for example, five minutes).

Further, the control unit 330 receives the advertising request information (or an advertising transmitting request signal) transmitted from the user device 100 by means of the communication unit 310. Here, the advertising request information may include information on a total number of accounts.

Further, the control unit 330 checks at least one advertising material (or product/product information) related to the user device 100 in a plurality of exposing accounts and the exposing location which are stored in advance in the storage unit 320.

Further, the control unit 330 transmits the checked at least one advertising material (or product/product information) and the information on the exposing location (or exposing location for every advertising material/exposing location information for every advertising material) to the user device 100 by means of the communication unit 310, in response to the received advertising request information.

The display device 340 may display various contents such as various menu screens using a user interface and/or graphic user interface stored in the storage unit 320, by the control of the control unit 330. Here, the contents displayed on the display unit 340 may include a menu screen including various texts, image data (including various information data), and data such as icons, list menus, or a combo boxes. The display unit 340 may be a touch screen. In this case, a touch sensor which detects a touch gesture of the user may be included. The touch sensor may be any one of various types such as a capacitive type, a decompressive type, or a piezoelectric type. In the case of the capacitive type, when a part of a user's body touches a surface of the touch screen by using a dielectric coated on the surface of the touch screen, a touch coordinate is calculated by sensing minute electricity excited to the user's body. In the case of the decompressive type, two electrode plates are embedded in the touch screen, and when the user touches the screen, upper and lower electrode plates contact each other at the touched position and then current flows, and the touch coordinate is calculated by sensing the flow of the current. In addition to this, the user device supports a pen input function. In this case, a gesture of the user utilizing an input unit such as a pen, rather than the part of the body of the user, may be sensed. For example, when the input unit is a stylus pen in which a coil is included, the user device may include a magnetic field sensor for sensing a magnetic field changed by the coil in the stylus pen. In this case, not only the touch gesture of the user, but also approaching gesture of the user, such as hovering may be detected.

Further, the display unit 340 may be implemented by at least one of a liquid crystal display (LCD), a thin film transistor liquid crystal display (TFT LCD), an organic light emitting diode (OLED), a flexible display, a three dimensional display (3D display), an electronic ink (e-ink) display, and a light emitting diode (LED) and also include a driving circuit therefor and a back light unit together.

Further, the display unit 340 displays one or more product information (or product information corresponding to the viewed product) checked by the user device 100, the information on a specific site, and the identification information of the user device 100, by the control of the control unit 330.

Further, the display unit 340 displays the response score for every product attribute calculated by the control of the control unit 330.

The voice output unit 350 outputs voice information included in a signal-processed signal by the control unit 330. Here, the voice output unit 350 may include a receiver, a speaker, a buzzer, and the like.

Further, the voice output unit 350 outputs a guidance voice generated by the control unit 330.

Further, the voice output unit 350 outputs voice information corresponding to the response score for every product attribute calculated by the control of the control unit 330.

Further, the service providing device 300 may be implemented in a form such as a web server, a database server, and a proxy server. Further, in the service providing device 300, one or more of various software which allows a network load distribution mechanism or a service providing device 300 to operate on the Internet or other networks may be installed, and as a result, the service providing device 300 may be implemented by a computerized system. Further, the network may be an http network and may be a private line, Intranet, or any other networks. Furthermore, the service providing device 300 and the user device 100 or the advertising terminal 200 may be connected to each other by a security network so as to suppress the data from being attacked by any hacker or other third parties. Further, the service providing device 300 may include a plurality of database servers. The database server may be implemented to be separately connected with the service providing device 300 through any type of network connection including a distributed database server architecture.

Further, a processor mounted in the user device 100, the advertising terminal 200 or the service providing device 300 according to the embodiment of the present invention may process the program command to execute the method according to the exemplary embodiment of the present invention. In an implemented embodiment, the processor may be a single-threaded processor. In another implemented embodiment, the processor may be a multi-threaded processor. Further, the processor may process the command stored on the memory or the storage device.

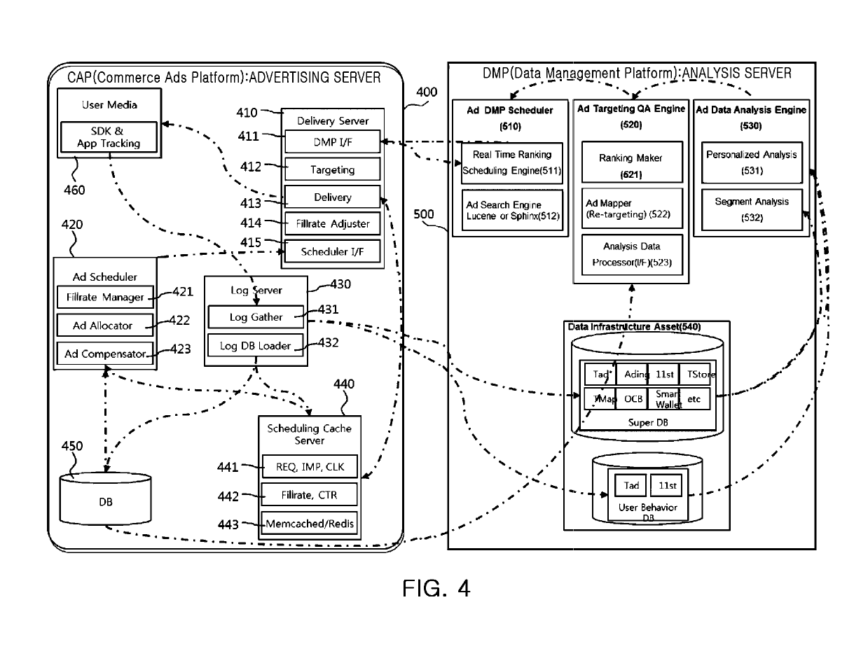

FIG. 4 is a view illustrating an advertising platform architecture linked with a DMP platform according to an embodiment of the present invention. Here, the functions of the advertising server 400 and an analysis server 500 may be performed by the service providing device 300. In this case, a machine learning manner has been applied to a data management platform (DMP platform).

As illustrated in FIG. 4, the advertising server 400 is constituted by a delivery server 410, an advertising scheduler 420, a log server 430, a scheduling cache server 440, a database 450, and a user media 460. However, all the constituent elements of the advertising server 400 illustrated in FIG. 4 are not essential constituent elements, and the advertising server 400 may be implemented by more constituent elements than the constituent elements illustrated in FIG. 4 or less constituent elements therethan.

The delivery server 410 is constituted by a DMP I/F 411, targeting 412, delivery 413, a fill rate (FR) adjuster 414, and a scheduler I/F 415.

The DMP I/F (data management platform interface) 411 is an interface between the delivery server 410 and the advertising DMP scheduler 510 of the analysis server 500 and returns an optimal advertising using an MDN or a device ID as keys.

The targeting 412 performs an exact targeting function.

The delivery 413 performs a function of transmitting an advertising as a response with respect to a request from the user media 460 (or SDK).

The FR adjuster 414 performs a function (or an algorithm) of adjusting fill rate (FR) in real time.

The scheduler I/F (scheduler interface) 415 performs a function of receiving advertising scheduling information (for example, including an advertising quantity, and an FR adjustment value) created by the scheduler.

An AD scheduler (advertising scheduler) 420 is constituted by a fill rate manager (FR manager) 421, an advertising allocator (AD allocator) 422, and an advertising compensator (AD compensator) 423.

The FR manager 421 performs a function of adjusting an advertising quantity to adjust the FR.

The AD allocator 422 performs a function of adjusting and allocating a quantity of advertising according to a runout rate.

The AD compensator 423 performs a compensating function according to the runout rate.

The log server 430 is constituted by a log gather 431 and a log database loader 432.

The log gather 431 receives a log as it is and stores the log as a file.

Further, the log gather 431 performs a function of storing the sales rate and the number of clicks in the scheduling cache server 440 in real time.

Further, the log gather 431 performs a function of detecting click fraud and exposure fraud based on the sales rate and the number of clicks.

The log database loader 432 stores the data which is stored by the log gather 431 as a file in a database.

Further, the log database loader 432 performs a function of charging and counting for data stored in the database.

The scheduling cache server 440 is constituted by a request, impression, click storage unit 441 and a FR and click through rate storage unit 442.

The request, impression, and click storage unit 441 performs a function of transmitting log information provided from the SDK of the user media 460 to the log server 430 and storing the request in the scheduling cache server 440.

The FR and CTR storage unit 442 performs a function of storing the FR and the CTR based on the request, the impressions, and the clicks which are provided from the delivery 413 and the log server 430.

The database 450 performs a function of storing advertising media meta information.

Further, the database 450 further performs a function of storing statistics and a report log.

As illustrated in FIG. 4, the analysis server 500 is constituted by an AD DMP scheduler 510, an AD targeting QA engine 520, an AD data analysis engine 530, and a DI DB 540. However, all the constituent elements of the analysis server 500 illustrated in FIG. 4 are not essential constituent elements, and the analysis server 500 may be implemented by more constituent elements than the constituent elements illustrated in FIG. 4 or less constituent elements therethan.

The Ad DMP scheduler 510 is constituted by a real time ranking scheduling engine 511 and an Ad search engine 512.

The real time ranking scheduling engine 511 receives a request from the delivery server 410 to search for a user customized advertising using the ad search engine 512 in real time to provide the user customized advertising to the delivery server 410.

Further, the real time ranking scheduling engine 511 performs a function of receiving the click through rate from the delivery server 41->410 as a response to adjust a ranking of an advertising list of the ad search engine 512.

The ad search engine 512 may be a search index server which has a user ID as a key and an advertising (or product) list and an exposure time as values.

The ad targeting QA engine 520 is constituted by a rank marker 521, an ad mapper 522, and an analysis data processor 523.

The rank marker (or ranking maker) 521 performs a function of assigning a rank using analyzed data (for example, including FR, CTR, request, impression, and click which are required to be represented by numerical values) from the ad data analysis engine 530.

The ad mapper 522 performs a function of connecting the advertising and the analysis data. In this case, the advertising may include a retargeted advertising.

The analysis data processor 523 performs a function of receiving data from the ad data analysis engine 530 and processes or converts the data to be easily used if necessary.

The ad data analysis engine 530 constituted by personalized analysis 531 and segment analysis 532.

The personalized analysis 531 performs a function of analyzing personalized data.

The segment analysis 532 performs a function of analyzing segment data using grouping.

The DI DB (data infrastructure database) 540 is a super database in which an overall SDK log is stored.

Further, the user media 460 collects (or obtains) one or more product information (or product information corresponding to the viewed product) checked by the user device 100, the information on a specific site, and the identification information of the user device 100.

As described above, information collected by the user media 460 is stored in the DI DB 540.

Further, the segment analysis 532 included in the ad data analysis engine 530 performs an analysis function by the function which is previously performed by the control unit 330 using data stored in the DI DB 540.

Further, when the advertising transmitting request is received, the information (for example, including at least one advertising material (or at least one product information) and information on the exposing location) analyzed by the segment analysis 532 may be transmitted to the user device 100.

Here, the functions of the advertising server 400 and an analysis server 500 according to the embodiment of the present invention may be performed by the service providing device 300.

As described above, when the retargeting advertising material is exposed, it is possible to determine the number of advertising materials to be exposed and an exposing location based on the response score for every advertising material calculated based on a click through rate, the sales rate, and the sales of the previously viewed product, the recommendation analysis product, and the advertiser product and the predetermined priority information and provides the advertising material to the terminal according to the previously determined number of advertising materials and the exposing location when the terminal requests an advertising.

Hereinbelow, a control method of a retargeting advertising product recommending system according to an embodiment of the present invention will be described in detail with reference to FIGS. 1 to 7.

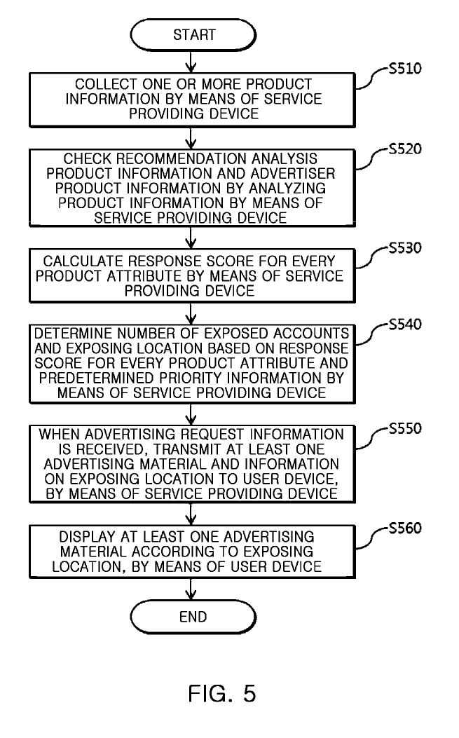

FIG. 5 is a flowchart illustrating a control method of a retargeting advertising product recommending system according to an embodiment of the present invention.

First, the user device 100 accesses a specific site to check one or more product information (or product) provided at the specific site. In this case, the service providing device 300 collects (or obtains) one or more product information (or product information corresponding to the viewed product) checked by the user device 100, the information on a specific site, and the identification information of the user device 100. Here, the product information includes a product unique code, a product name, a product image, and product description information. Further, the identification information of the user device 100 includes a mobile directory number (MDN), a mobile IP, a mobile MAC, a subscriber identify module (Sim) card unique information, and a serial number.

That is, the user device 100 checks the tracking log information and transmits (or provides) the checked tracking log information, information on the specific site, and the identification information of the user device 100 to the service providing device 300.

For example, when the user device 100 accesses a first online shopping mall to check first to fifth product information provided in the first online shopping mall, the user device 100 transmits (or provides) product information on the checked first to fifth products, information (for example, including an address and a name of the first online shopping mall) on the accessed first online shopping mall, and the identification information of the user device 100 to the service providing device 300. Further, the service providing device 300 receives product information on the first to fifth products transmitted from the user device 100, information on the accessed first online shopping mall (for example, including an address and a name of the first online shopping mall), and the identification information of the user device 100 (S510).

Next, the service providing device 300 analyzes one or more product information (or product information corresponding to the viewed product) checked in the user device 100 to check one or more recommendation analysis product information on products of interest of the user of the user device 100 among a plurality of product information which is stored in advance in the service providing device 300.

Further, the service providing device 300 checks one or more advertiser product information among a plurality of advertiser product information provided from the plurality of advertising terminals 200 based on one or more product information checked by the user device 100.

For example, the service providing device 300 analyzes the first to fifth product information checked by the user device 100 to check eleventh to seventeenth recommendation analysis product information among the plurality of product information (or a plurality of recommendation analysis product information) stored in the service providing device 300. Further, the service providing device 300 checks twenty first to twenty sixth advertiser product information related to the first to fifth product information among the plurality of product information (or a plurality of advertiser product information) provided to the plurality of advertising terminals 200 (S520).

Next, the service providing device 300 calculates a response score for every product attribute for every advertising material such as one or more product information checked by the user device 100, the checked one or more recommendation analysis product information, and the checked one or more advertiser product information.

That is, the service providing device 300 calculates a response score (or a response score for every product attribute) according to the product attribute based on a click through rate (CTR), a sales rate, sales, and the like for one or more product information checked in the user device 100 as represented in the above-described Equation 1.

Further, the service providing device 300 calculates the response score by the product attribute by the above-described Equation 1, based on the click through rate, the sales rate, the number of sales, and the like for the one or more recommendation analysis product information checked by means of the service providing device 300.

Further, the service providing device 300 calculates the response score by the product attribute by the above-described Equation 1, based on the click through rate, the sales rate, the number of sales, and the like for the one or more advertiser product information provided from the advertising terminal 200.

For example, the service providing device 300 calculates respectively a response score for every product attribute for information on the first to fifth products which are viewed by the user device 100, eleventh to seventeenth recommendation analysis product information which is a result analyzed by the service providing device 300, and twenty first to twenty sixth advertiser product information recommended by the advertising terminal 200 (S530).

Further, the service providing device 300 determines (or sets) the number of advertising materials to be exposed (or the number of exposing accounts) and the exposing location based on the calculated response score for every product attribute and the predetermined priority information. Here, according to the predetermined priority information, the priority may be higher in the order of the response score for every product attribute, the sales rate, the number of sales, the click through rate, the number of clicks, the number of impressions, and the like.

That is, the service providing device 300 determines a rate of the number of accounts to be exposed among the total number of accounts with a rate of a response score of a specific advertising material (for example, including the viewed product, the recommendation analysis product, and the advertiser product) among the total of the response scores for every product attribute which is previously calculated based on the above-described Equation 2. In this case, the numerical values below decimal points are truncated.

Further, when the number of exposing accounts is calculated, the service providing device 300 calculates the number of exposing accounts in the order of higher priority, based on predetermined priority information. Next, the service providing device 300 subtracts the number of exposing accounts having a high priority attribute which is previously calculated from the total number of accounts, so that a problem in that the product is empty in the account is not caused.

Further, the service providing device 300 determines the exposing location in the order of the product viewed in the user device 100, the recommendation analysis product, and the advertiser product, based on the predetermined priority information.

For example, when nine exposing accounts are provided, the service providing device 300 calculates respectively rates of a response score for the product viewed by the user device 100, a response score for the recommendation analysis product information which is an analysis result in the service providing device 300, and a response score for the advertiser product information recommended by the advertising terminal 300 with respect to the total of the response scores for product attributes calculated for the first to fifth products which are products viewed by the user device 100, the eleventh to seventeenth recommendation analysis products which are results analyzed by the service providing device 300, and the twenty first to twenty sixth advertiser products recommended by the advertising terminal 200 to determine respectively four exposed accounts of the products viewed by the user device 100, three exposed accounts of the recommendation analysis products, and two exposed accounts of the advertiser products.

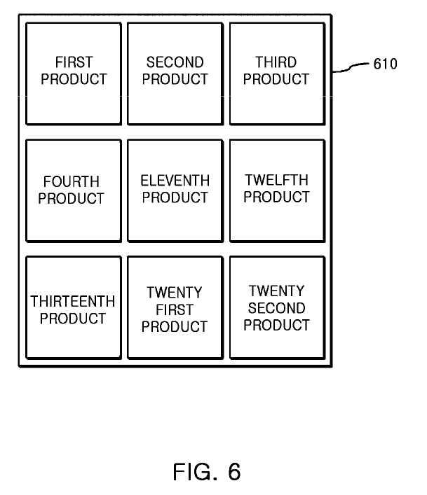

Further, as illustrated in FIG. 6, the service providing device 300 determines the exposing locations 610 in the order of the first to fourth products among products viewed by the user device 100, the eleventh to thirteenth recommendation analysis products among the recommendation analysis products, and the twenty first and twenty second advertiser products among the advertiser products based on the predetermined priority information (S540).

Next, when the service providing device 300 receives the advertising request information transmitted from the user device 100, the service providing device 300 provides (or transmits) at least one advertising material (or product/product information), information on the exposing location (or exposing location for every advertising material/exposing location information for every advertising material), and the like to the user device 100 based on the previously determined number of exposed accounts and the exposing location.

For example, when the service providing device 300 receives the advertising request information transmitted from the user device 100, the service providing device 300 transmits product information on total nine products including product information on the first to fourth products among products viewed by the user device 100, product information on the eleventh to thirteenth recommendation analysis products among the recommendation analysis products, and product information on the twenty first and twenty second advertiser products among the advertiser products, and information on the exposing location for every product information, which are previously determined, in response to the received advertising request information to the user device 100 (S550).

Next, the user device 100 receives at least one advertising material (or at least one product information) transmitted from the service providing device 300, information on the exposing location (or exposing location for every advertising material/exposing location information for every advertising material), and the like in response to the transmitted advertising request information.

Further, the user device 100 displays the received at least one advertising material based on the exposing location determined by the service providing device 300.

That is, the user device 100 displays at least one advertising material based on the received information on the exposing location.

For example, the user device 100 receives product information on the first to fourth products among viewed products, product information on the eleventh to thirteenth recommendation analysis products among the recommendation analysis products, and product information on the twenty first and twenty second advertiser products, which are transmitted from the service providing device 300 in response to the transmitted advertising request information.

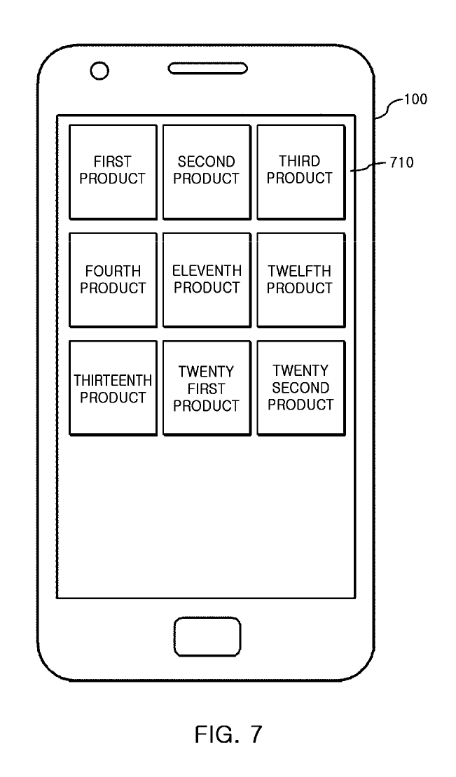

Further, as illustrated in FIG. 7, the user device 100 displays (710) product information on the first to third products among the viewed products in first to third accounts, product information on the fourth product among the viewed products and the eleventh and twelfth recommendation analysis products among the recommendation analysis products in the fourth to sixth accounts, and the thirteenth recommendation analysis product among the recommendation analysis products and twenty first and twenty second advertiser products among the advertiser products in seventh to ninth accounts, in three by three exposure format according to the exposing locations determined by the service providing device 300.

Here, the click through rates may have big difference depending on a location where the products are disposed (or the product account location). Therefore, when the advertising (or product information/product) is exposed by constituting an account with three by three format, click through rates of products in the first to third accounts which are located on a first row are very high. Further, the click through rates of the products in the fourth to sixth accounts which are located in a second row are a half lower than that of the accounts located in the first row. Further, the click through rates of the products in the seventh to ninth accounts which are located in a third row is approximately 60 to 70% of that of the second row.

Therefore, according to the embodiment of the present invention, even though the click through rate is high, but the click through rate may vary depending on the type of product to be exposed, so that the location where the product is exposed may be determined (or set) in consideration of the type of product.

That is, when the viewed product is exposed through an advertising at first, the click through rate of the viewed product may be high because the user of the user device 100 may be interested in the product to view the product or the product put in the cart is exposed. However, when the same product is consistently exposed for a long time because the user does not view other product than the viewed product, the click through rate is lowered.

In this case, when the click through rate and the sales rate of the recommendation analysis product are high, if the recommendation analysis product is exposed through consultation, the advertising effect may be further increased.

Further, in the case of the advertiser product, products having an advertising response rate may be registered according to seasons or events. In this case, the advertiser products which are exposed in the accounts (or the lowest accounts) of the third row are automatically exposed in the first row (or the uppermost account) to maximize the advertising effect.

Further, when the number of products which are exposed in the accounts for every attribute of the product (for example, including the viewed product, the recommendation analysis product, and the advertiser product) is automatically corrected in accordance with the advertising effect which is checked in real time, better advertising effect may be achieved (S560).

The retargeting advertising product recommending user device and service providing device, and the advertising product recommending system including the same according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the computer or the user device, the advertising terminal, the service providing device, and the like according to the exemplary embodiment of the present invention to implement the retargeting advertising product recommending user device, service providing device, and the advertising product recommending system including the same.

The non-transitory computer readable storage medium includes a magnetic storage medium, an optical storage medium, and a carrier wave medium. A computer program implementing the retargeting advertising product recommending user device, service providing device, and the advertising product recommending system including the same according to the embodiment of the present invention may be stored and installed in an internal memory of the user device, the advertising terminal, the service providing device, and the like. Alternately, an external memory such as a smart card storing and installing the computer program implementing the retargeting advertising product recommending user device, service providing device, and the advertising product recommending system including the same according to the embodiment of the present invention may be installed in an internal memory of the user device, the advertising terminal, the service providing device, and the like through an interface.

According to the present invention, when are targeting advertising material is exposed, a number of advertising materials to be exposed and an exposing location are determined based on a response score for every advertising material calculated based on a click through rate, a sales rate, and the number of sales for every advertising material such as a previously viewed product, an recommendation analysis product, and an advertiser product and predetermined priority information, and when the terminal requests an advertising, the advertising material is provided to the terminal according to the number of advertising materials and the exposing location which are previously determined, thereby maximizing an advertising effect through the number of advertising material to which the CTR and the sales rate are reflected according to the product attribute and the exposing location and increasing the satisfaction of the user.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

### INDUSTRIAL APPLICABILITY

According to the present invention, when are targeting advertising material is exposed, a number of advertising materials to be exposed and an exposing location are determined based on a response score for every advertising material calculated based on a click through rate, a sales rate, and the number of sales for every advertising material such as a previously viewed product, an recommendation analysis product, and an advertiser product and predetermined priority information, and when the terminal requests an advertising, the advertising material is provided to the terminal according to the number of advertising materials and the exposing location which are previously determined, thereby maximizing an advertising effect through the number of advertising material to which the CTR and the sales rate are reflected according to the product attribute and the exposing location and increasing the satisfaction of the user and can be widely used in a user device field, an advertising field, a retargeting product recommending field, and the like.

1. A service providing device, comprising:
a storage unit which stores product information on a plurality of products and advertiser product information provided from an advertising terminal;
a communication unit which receives one or more product information corresponding to a viewed product, information on a specific site, and identification information of a user device which are transmitted from the user device; and
a control unit which analyzes the received one or more product information to check one or more recommendation analysis product information and one or more advertiser product information among a plurality of product information stored in the storage unit, calculate a response score for every product attribute for the one or more product information, the one or more recommendation analysis product information, and the one or more advertiser product information, and determine a number of exposed accounts to be exposed and an exposing location based on the calculated response score for every product attribute and predetermined priority information.

2. The device of claim 1, wherein the product information includes at least one of a product unique code, a product name, a product image, and product description information.

3. The device of claim 1, wherein the control unit calculates a response score for every product attribute for the one or more product information by adding a click through rate to a value obtained by multiplying a sales rate and sales on the one or more product information, calculates a response score for every product attribute for the recommendation analysis product information by adding a click through rate to a value obtained by multiplying a sales rate and sales on the recommendation analysis product information, and calculates a response score for every product attribute for the advertiser product information by adding a click through rate to a value obtained by multiplying a sales rate and sales on the advertiser product information.

4. The device of claim 1, wherein according to the predetermined priority information, the priority is higher in the order of the response score for every product attribute, the sales rate, the number of sales, the click through rate, the number of clicks, and the number of impressions.

5. The device of claim 1, wherein when the advertising request information transmitted from the user device is received by means of the communication unit, the control unit controls the communication unit to transmit information on at least one advertising material and an exposing location to the user device based on the determined number of exposed accounts and the exposing location.

6. A control method of a service providing device, the control method comprising:
receiving one or more product information corresponding to a viewed product, information on a specific site, and identification information of a user device which are transmitted from the user device, by means of a communication unit;
checking one or more recommendation analysis product information and one or more advertiser product information among a plurality of product information stored in a storage unit by analyzing the received one or more product information, by means of a control unit;
calculating response scores for every product attribute for the one or more product information, the one or more recommendation analysis product information and the one or more advertiser product information, by means of the control unit; and
determining the number of exposed accounts to be exposed and exposing locations based on the calculated response score for every product attribute and predetermined priority information, by means of the control unit.

7. The control method of claim 6, wherein the calculating of a response score for every product attribute includes at least one process of:
calculating a response score for every product attribute for the one or more product information by adding a click through rate to a value obtained by multiplying a sales rate and sales on the one or more product information, by means of the control unit;
calculating a response score for every product attribute for the recommendation analysis product information by adding a click through rate to a value obtained by multiplying a sales rate and sales on the recommendation analysis product information; and
calculating a response score for every product attribute for the advertiser product information by adding a click through rate to a value obtained by multiplying a sales rate and sales on the advertiser product information.

8. The control method of claim 6, further comprising:
receiving advertising request information transmitted from the user device, by means of the communication unit; and
controlling the communication unit to transmit information on at least one advertising material and the exposing location based on the determined number of exposed accounts and exposing location in response to the received advertising request information to the user device, by means of the control unit.

9. A non-transitory computer readable storage medium having a computer program recorded thereon configured to perform the method according to claim 6.

10. An advertising product recommending system, comprising:
a service providing device which checks one or more recommendation analysis product information and one or more advertiser product information among a plurality of product information previously stored by analyzing one or more product information corresponding to a viewed product transmitted from a user device, calculates respectively response scores for every product attribute for the one or more product information, the one or more recommendation analysis product information, and the one or more advertiser product information, determines a number of exposed accounts to be exposed and exposing locations based on the calculated response score for every product attribute and predetermined priority information, and when the advertising request information transmitted from the user device is received by means of the communication unit, transmits information on at least one advertising material and an exposing location to the user device based on the determined number of exposed accounts and the exposing location; and
a user device which receives information on the at least one advertising material and the exposing location transmitted from the service providing device in response to the advertising request information and displays the at least one advertising material based on the information on the exposing location.

11. A non-transitory computer readable storage medium having a computer program recorded thereon configured to perform the method according to claim 7.

12. A non-transitory computer readable storage medium having a computer program recorded thereon configured to perform the method according to claim 8.
